(19) United States
(12) Patent Application Publication
(10) Pub. No.: US 2021/0157543 A1
(43) Pub. Date: May 27, 2021

(54) PROCESSING OF MULTIPLE AUDIO STREAMS BASED ON AVAILABLE BANDWIDTH

(71) Applicant: QUALCOMM Incorporated, San Diego, CA (US)

(72) Inventors: S M Akramus SALEHIN, San Diego, CA (US); Siddhartha Goutham SWAMINATHAN, San Diego, CA (US)

(21) Appl. No.: 16/696,798

(22) Filed: Nov. 26, 2019

(51) Int. Cl. G06F 3/16; G10L 21/0388; G10L 19/16; H04L 29/06

(52) U.S. Cl. CPC G06F 3/165; G10L 21/0388; H04L 65/80; H04L 65/607; H04L 65/601; G10L 19/167

(57) ABSTRACT

Methods, systems, and devices for processing of multiple audio streams based on available bandwidth are described. Described techniques provide for receiving, at a device, one or more audio streams, identifying an available bandwidth for processing the one or more audio streams, locating (based on the available bandwidth) a first set of one or more objects contributing to the one or more audio streams that are located within a threshold radius from the device, and generating an object-based audio stream. The described techniques further provide for extracting a contribution of the first number of objects from the one or more audio streams, generating an HOA audio stream, and outputting an audio feed that includes the HOA audio stream and the object-based audio stream.

### BACKGROUND

The following relates generally to auditory enhancement, and more specifically to processing of multiple audio streams based on available bandwidth.

Virtual reality systems may provide an immersive user experience. An individual moving with six degrees of freedom may experience improved immersion in such a virtual reality scenario (e.g., as opposed to only three degrees of freedom). However, processing audio streams as a combination of audio objects and a single higher order ambisonics (HOA) stream may not support listener movement (e.g., in six degrees of freedom).

### SUMMARY

The described techniques relate to improved methods, systems, devices, and apparatuses that support processing of multiple audio streams based on available bandwidth. Generally, the described techniques provide for receiving, at a device (e.g., a streaming device connected to a virtual reality (VR) device, a device including a VR device such as a VR headset, or the like), one or more audio streams, identifying an available bandwidth for processing the one or more audio streams, locating (based on the available bandwidth) a first set of one or more objects contributing to the one or more audio streams that are located within a threshold radius from the device, and generating an object-based audio stream. The described techniques further provide for extracting a contribution of the first number of objects from the one or more audio streams, generating (e.g., via HOA encoding on a remainder of the one or more audio streams after the extracting of the contribution of the first set of one or more objects) an HOA audio streams, and outputting an audio feed (e.g., for a VR system such as a VR headset) that includes the HOA audio stream and the object-based audio stream.

### BRIEF DESCRIPTION OF THE DRAWINGS

### DETAILED DESCRIPTION

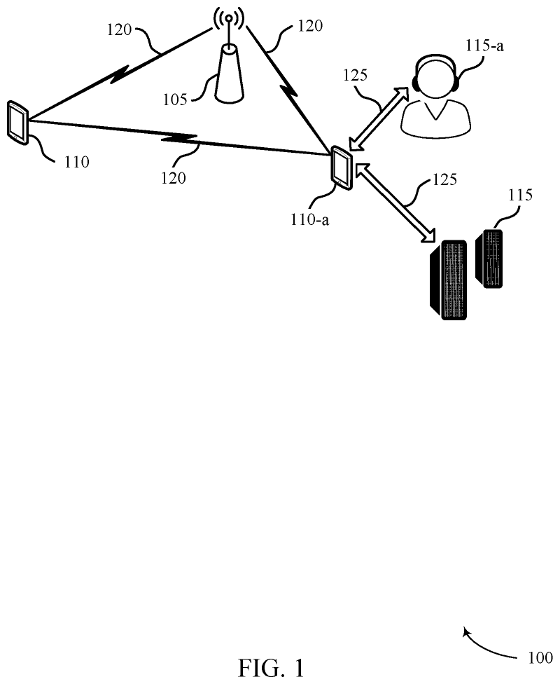

FIG. 1 illustrates an example of a system for wireless communications that supports processing of multiple audio streams based on available bandwidth in accordance with aspects of the present disclosure.

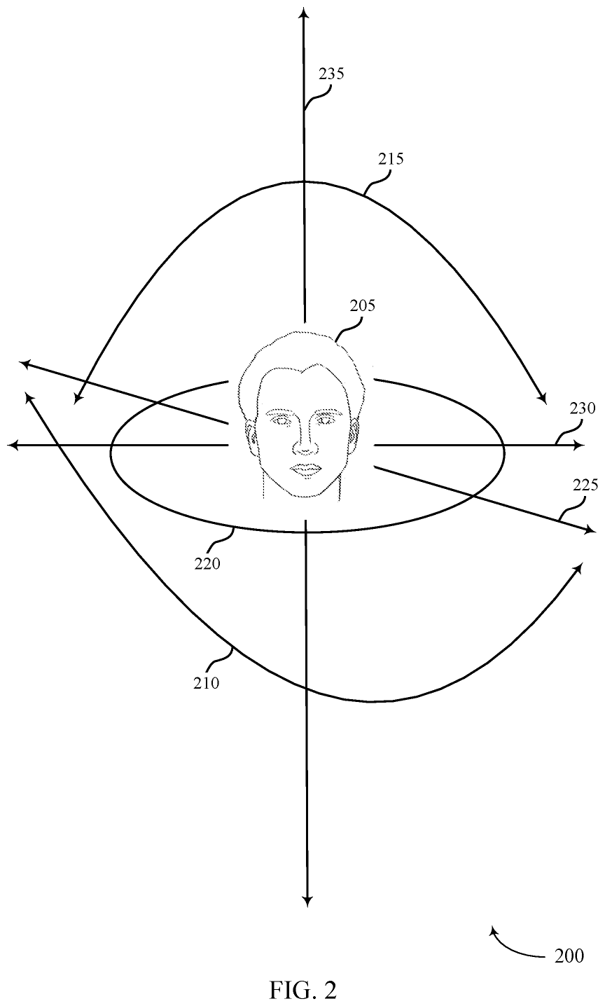

FIG. 2 illustrates an example of a degrees of freedom scenario that supports processing of multiple audio streams based on available bandwidth in accordance with aspects of the present disclosure.

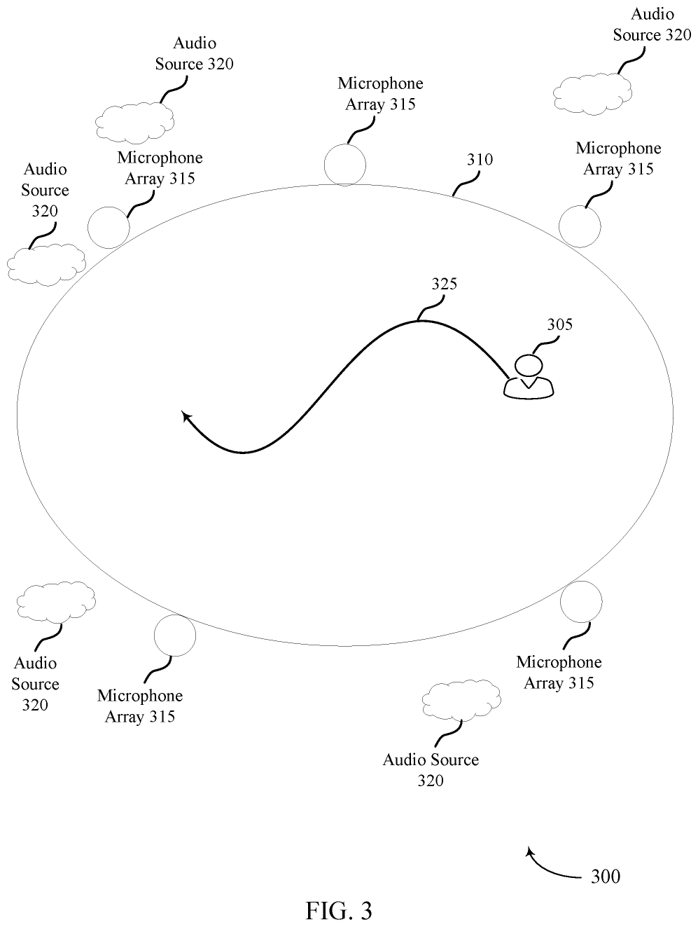

FIG. 3 illustrates an example of a virtual reality scenario that supports processing of multiple audio streams based on available bandwidth in accordance with aspects of the present disclosure.

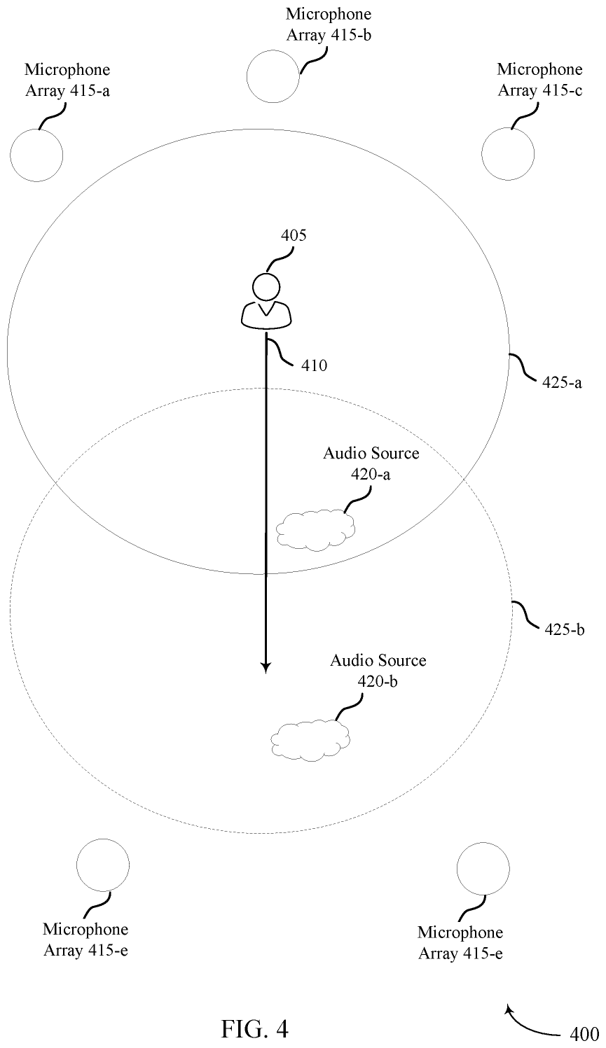

FIG. 4 illustrates an example of a virtual reality scenario that supports processing of multiple audio streams based on available bandwidth in accordance with aspects of the present disclosure.

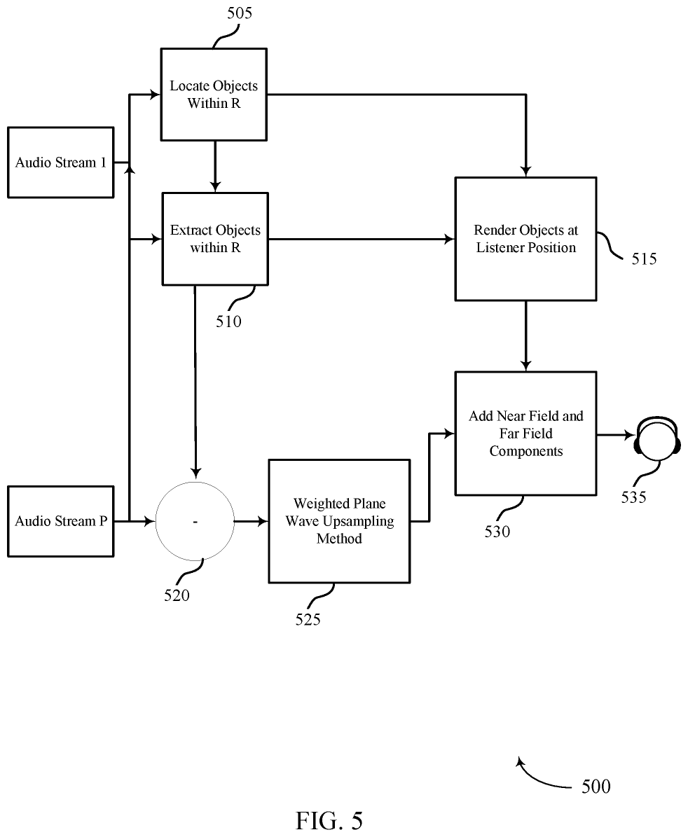

FIG. 5 illustrates an example of a process flow that supports processing of multiple audio streams based on available bandwidth in accordance with aspects of the present disclosure.

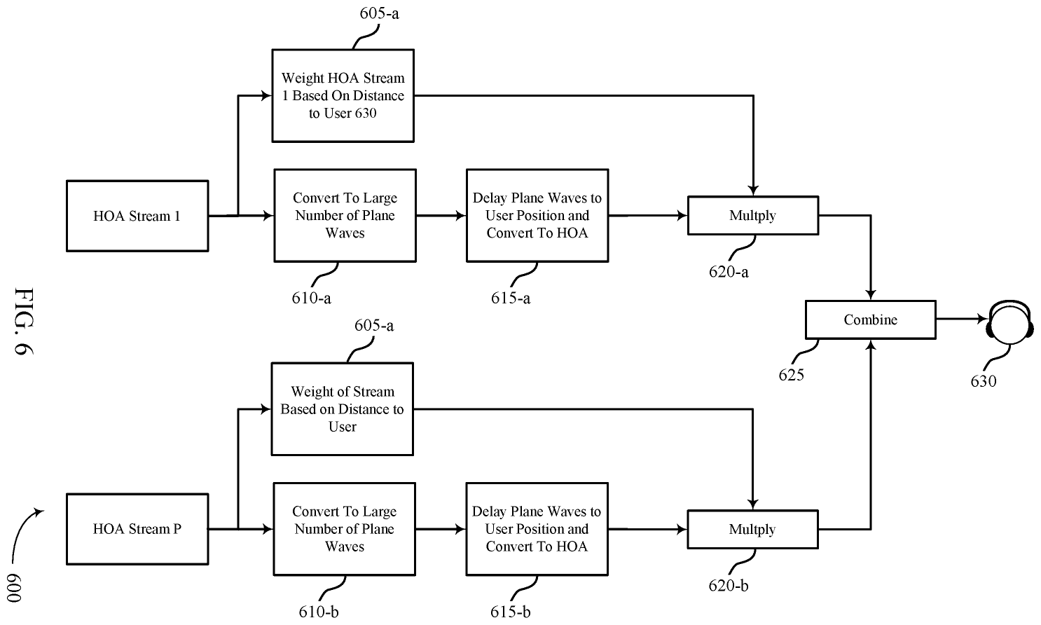

FIG. 6 illustrates an example of a process flow that supports processing of multiple audio streams based on available bandwidth in accordance with aspects of the present disclosure.

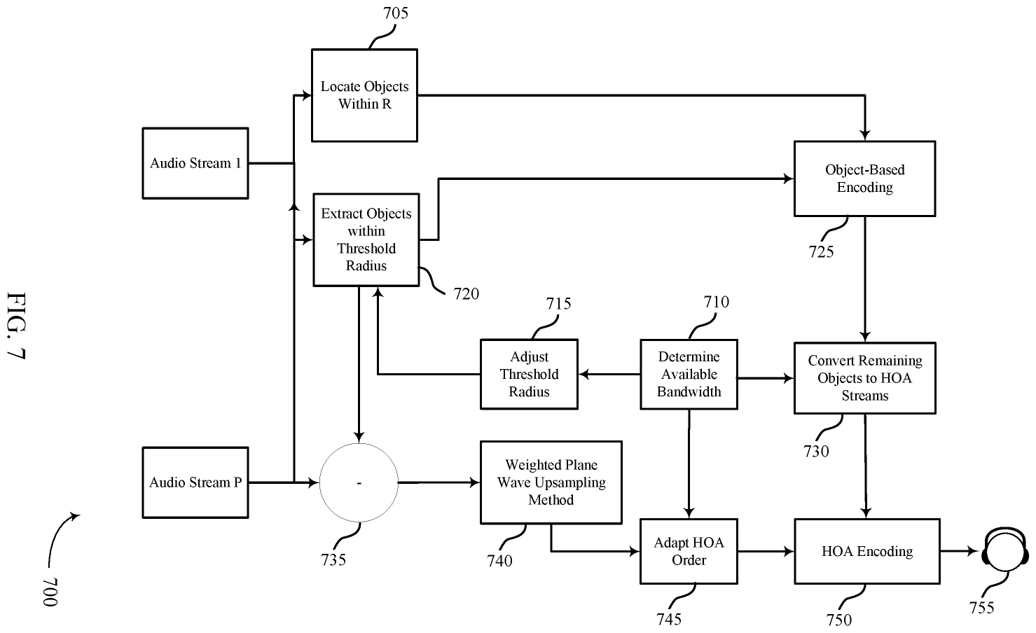

FIG. 7 illustrates an example of a process flow that supports processing of multiple audio streams based on available bandwidth in accordance with aspects of the present disclosure.

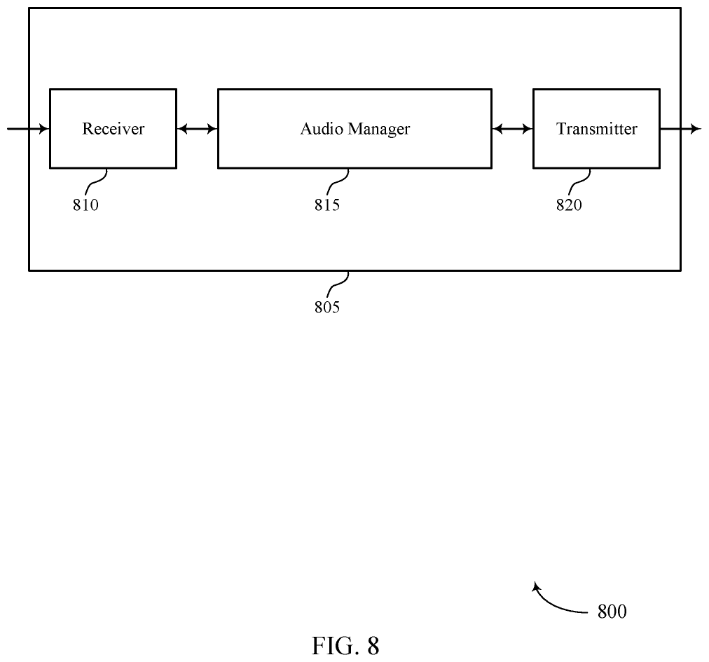

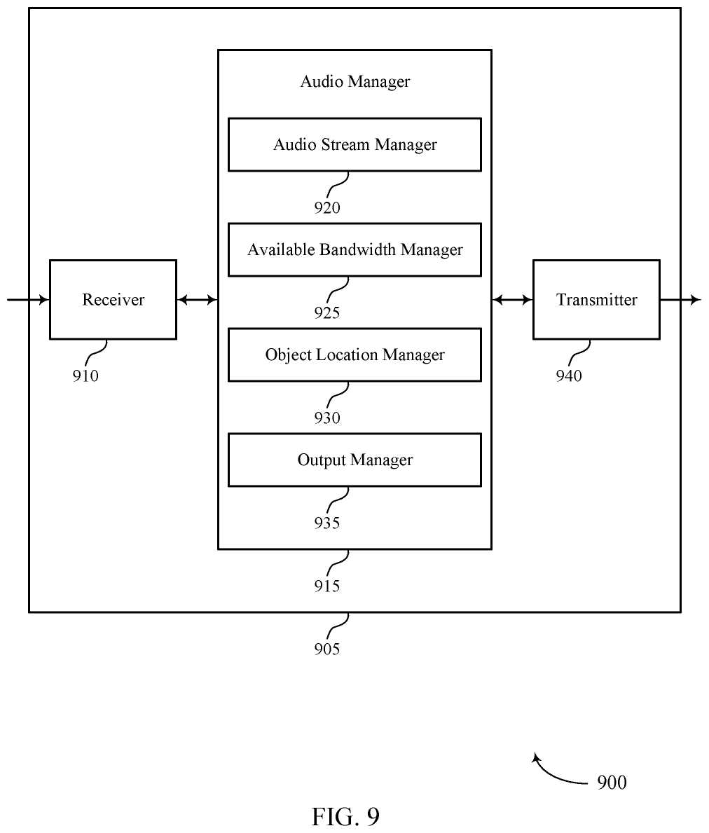

FIGS. 8 and 9 show block diagrams of devices that support processing of multiple audio streams based on available bandwidth in accordance with aspects of the present disclosure.

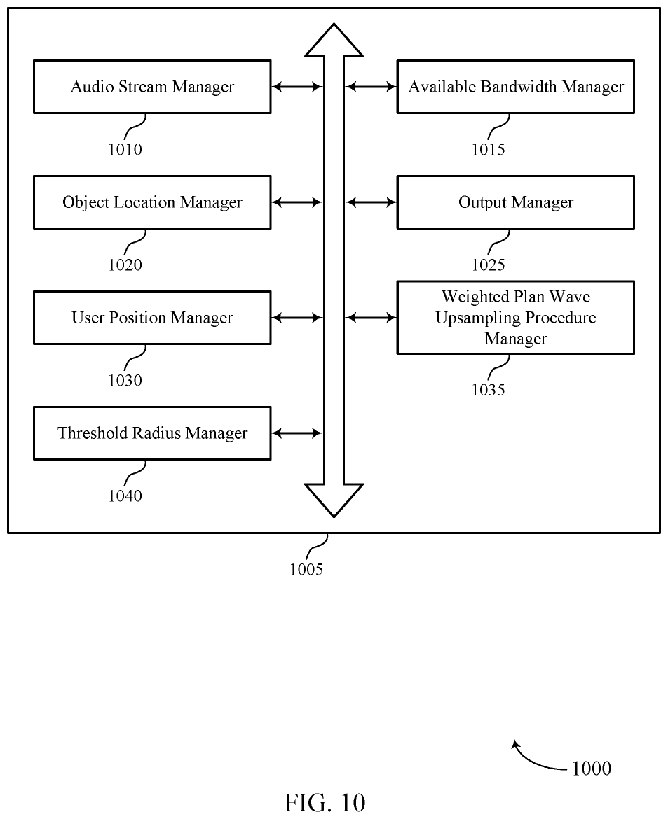

FIG. 10 shows a block diagram of an audio manager that supports processing of multiple audio streams based on available bandwidth in accordance with aspects of the present disclosure.

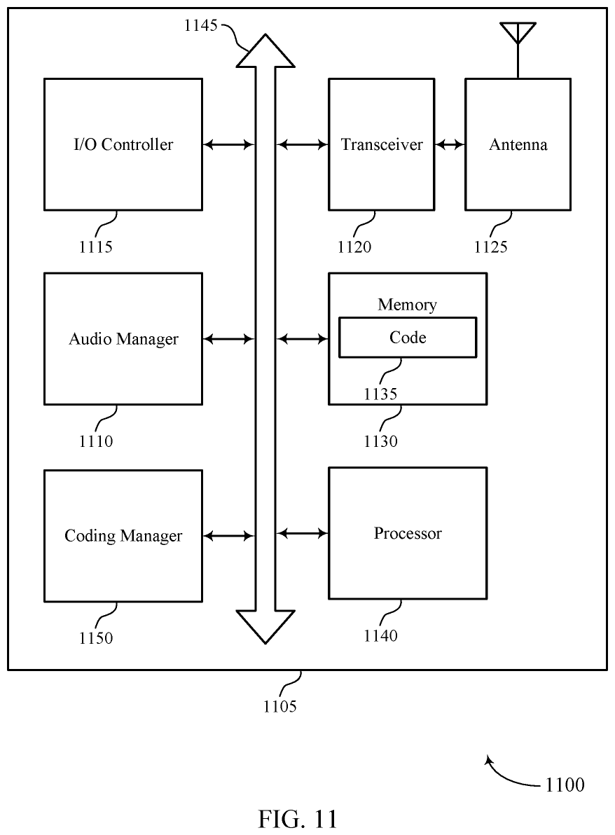

FIG. 11 shows a diagram of a system including a device that supports processing of multiple audio streams based on available bandwidth in accordance with aspects of the present disclosure.

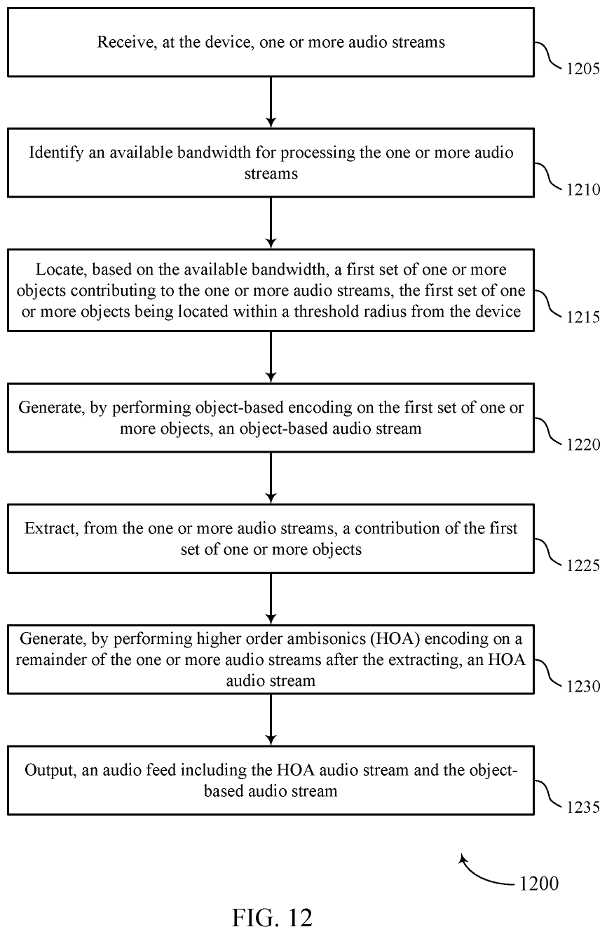

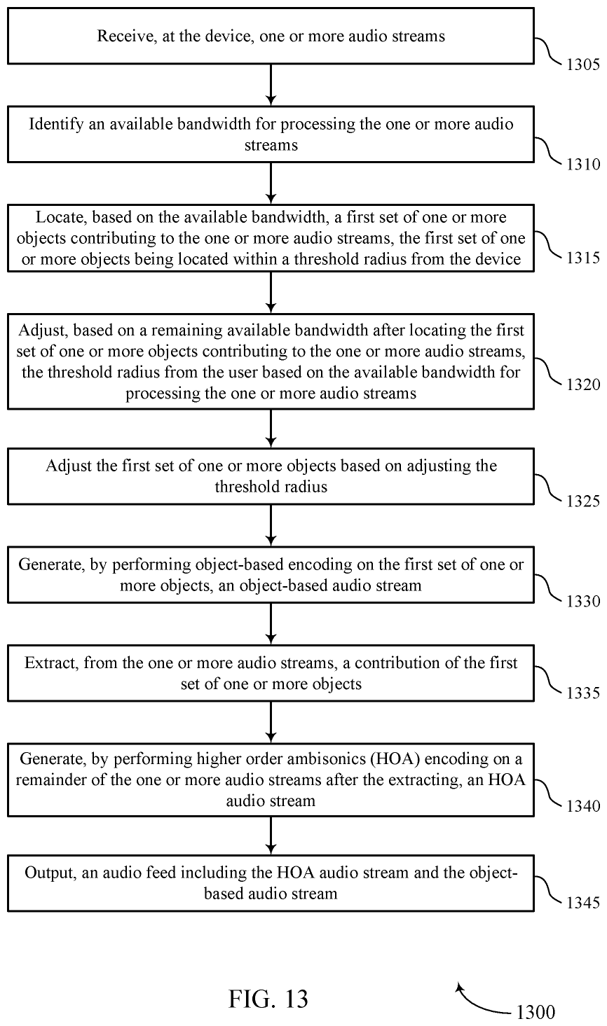

FIGS. 12 and 13 show flowcharts illustrating methods that support processing of multiple audio streams based on available bandwidth in accordance with aspects of the present disclosure.

Virtual reality systems may provide an immersive user experience. An individual moving with six degrees of freedom may experience improved immersion in such a virtual reality scenario (e.g., as opposed to only three degrees of freedom). However, conventional methods of processing audio streams as a combination of audio objects and a single higher order ambisonics (HOA) stream may not support listener movement (e.g., in six degrees of freedom). For instance, a user may move from one location to another, changing the position of a VR device (e.g., a VR headset, smart glasses, or the like). An audio processing device may perform audio encoding and send the encoded audio streams to a VR device to take into account the changes in audio a user should experience based on the user location, position, direction, etc.

User experience may be improved by ensuring that individual objects within a threshold radius of the user position are rendered using object-based encoding, while more distance objects, background noise, or both, are rendered using HOA encoding. Such encoding may be based on listener position, and thus may change rapidly with respect to time. However, an audio processing device may have a limited available bandwidth, which may affect the quality of audio signaling, or the capacity to adjust audio output as a user moves.

In some examples, an audio processing device may receive one or more audio streams for audio processing (e.g., from a streaming device, from an online source, or the like). The audio processing device may determine a number of objects within a threshold radius of the user, based on a determined available bandwidth and a current determined listener position. The audio processing device may perform object based encoding based thereon. To efficiently use available bandwidth, the audio processing device may adjust the threshold radius around the listener position (e.g., by expanding the radius to capture more objects or decrease the radius to capture less objects) based on the listener position and the available bandwidth. The audio processing device may then perform object based encoding on the identified objects within the threshold radius of the user position, and perform HOA encoding on remaining objects, background noise, etc. included in any number of input audio streams.

Aspects of the disclosure are initially described in the context of a multimedia system. Aspects of the disclosure are further illustrated by and described with reference to virtual reality scenarios, and process flows. Aspects of the disclosure are further illustrated by and described with reference to apparatus diagrams, system diagrams, and flowcharts that relate to processing of multiple audio streams based on available bandwidth.

FIG. 1 illustrates an example of a wireless communications system 100 that supports processing of multiple audio streams based on available bandwidth in accordance with aspects of the present disclosure. In some examples, the wireless communications system 100 may include or refer to a wireless personal area network (PAN), a wireless local area network (WLAN), a Wi-Fi network) configured in accordance with various aspects of the present disclosure. The wireless communications system 100 may include an access point (AP) 105, devices 110 (e.g., which may be referred to as source devices, master devices, etc.), and paired devices 115 (e.g., which may be referred to as sink devices, slave devices, etc.) implementing WLAN communications (e.g., Wi-Fi communications) and/or Bluetooth communications. For example, devices 110 may include cell phones, user equipment (UEs), wireless stations (STAs), mobile stations, personal digital assistant (PDAs), other handheld devices, netbooks, notebook computers, tablet computers, laptops, or some other suitable terminology. Paired devices 115 may include Bluetooth-enabled devices capable of pairing with other Bluetooth-enabled devices (e.g., such as devices 110), which may include wireless audio devices (e.g., headsets, earbuds, speakers, ear pieces, headphones), display devices (e.g., TVs, computer monitors), microphones, meters, valves, etc.

Bluetooth communications may refer to a short-range communication protocol and may be used to connect and exchange information between devices 110 and paired devices 115 (e.g., between mobile phones, computers, digital cameras, wireless headsets, speakers, keyboards, mice or other input peripherals, and similar devices). Bluetooth systems (e.g., aspects of wireless communications system 100) may be organized using a master-slave relationship employing a time-division duplex protocol having, for example, defined time slots of 625 mu seconds, in which transmission alternates between the master device (e.g., a device 110) and one or more slave devices (e.g., paired devices 115). In some examples, a device 110 may generally refer to a master device, and a paired device 115 may refer to a slave device in the wireless communications system 100. As such, in some examples, a device may be referred to as either a device 110 or a paired device 115 based on the Bluetooth role configuration of the device. That is, designation of a device as either a device 110 or a paired device 115 may not necessarily indicate a distinction in device capability, but rather may refer to or indicate roles held by the device in the wireless communications system 100. Generally, device 110 may refer to a wireless communication device capable of wirelessly exchanging data signals with another device (e.g., a paired device 115), and paired device 115 may refer to a device operating in a slave role, or to a short-range wireless communication device capable of exchanging data signals with the device 110 (e.g., using Bluetooth communication protocols).

A Bluetooth-enabled device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs (e.g., roles for a device 110 and a paired device 115) that together form a single use case called a profile (e.g., for communications between the device 110 and the paired device 115). One example profile defined in the Bluetooth specification is the Handsfree Profile (HFP) for voice telephony, in which one device (e.g., a device 110) implements an Audio Gateway (AG) role and the other device (e.g., a paired device 115) implements a Handsfree (HF) device role. Another example is the Advanced Audio Distribution Profile (A2DP) for high-quality audio streaming, in which one device (e.g., device 110) implements an audio source device (SRC) role and another device (e.g., paired device 115) implements an audio sink device (SNK) role.

For a commercial Bluetooth-enabled device that implements one role in a profile to function properly, another device that implements the corresponding role may be present within the radio range of the first device. For example, in order for an HF device such as a Bluetooth headset to function according to the Handsfree Profile, a device implementing the AG role (e.g., a cell phone) may have to be present within radio range. Likewise, in order to stream high-quality mono or stereo audio according to the A2DP, a device implementing the SNK role (e.g., Bluetooth headphones or Bluetooth speakers) may have to be within radio range of a device implementing the SRC role (e.g., a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having certain characteristics (e.g., flow control, acknowledgement mechanisms, repeat mechanisms, sequence numbering, scheduling behavior, etc.). The Bluetooth protocol stack may be split in two parts: a controller stack including the timing critical radio interface, and a host stack handling high level data. The controller stack may be generally implemented in a low cost silicon device including a Bluetooth radio and a microprocessor. The controller stack may be responsible for setting up connection links 125 such as asynchronous connection-less (ACL) links, (or ACL connections), synchronous connection orientated (SCO) links (or SCO connections), extended synchronous connection-oriented (eSCO) links (or eSCO connections), other logical transport channel links, etc.

A communication link 125 may be established between two Bluetooth-enabled devices (e.g., between a device 110 and a paired device 115) and may provide for communications or services (e.g., according to some Bluetooth profile). For example, a Bluetooth connection may be an eSCO connection for voice call (e.g., which may allow for retransmission), an ACL connection for music streaming (e.g., A2DP), etc. For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device (e.g., paired device 115) are acknowledged, and may be retransmitted if not acknowledged during a retransmission window. In addition, audio may be streamed between a device 110 and a paired device 115 using an ACL connection (A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power requirements), etc.

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 110 may support WLAN communications via AP 105 (e.g., over communication links 120). The AP 105 and the associated devices 110 may represent a basic service set (BSS) or an extended service set (ESS). The various devices 110 in the network may be able to communicate with one another through the AP 105. In some cases, the AP 105 may be associated with a coverage area, which may represent a basic service area (BSA).

Devices 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within wireless communications system 100, and devices may communicate with each other via communication links 120 (e.g., Wi-Fi Direct connections, Wi-Fi Tunneled Direct Link Setup (TDLS) links, peer-to-peer communication links, other peer or group connections). AP 105 may be coupled to a network, such as the Internet, and may enable a device 110 to communicate via the network (or communicate with other devices 110 coupled to the AP 105). A device 110 may communicate with a network device bi-directionally. For example, in a WLAN, a device 110 may communicate with an associated AP 105 via downlink (e.g., the communication link from the AP 105 to the device110) and uplink (e.g., the communication link from the device 110 to the AP 105).

In some examples, content, media, audio, etc. exchanged between a device 110 and a paired device 115 may originate from a WLAN. For example, in some examples, device 110 may receive audio from an AP 105 (e.g., via WLAN communications), and the device 110 may then relay or pass the audio to the paired device 115 (e.g., via Bluetooth communications). In some examples, certain types of Bluetooth communications (e.g., such as high quality or high definition (HD) Bluetooth) may require enhanced quality of service. For example, in some examples, delay-sensitive Bluetooth traffic may have higher priority than WLAN traffic.

In some examples, a device 110 (e.g., ear pieces, headphones, etc.) may be an example of VR devices (e.g., a VR headset, smart glasses, or the like). An audio processing device (e.g., a personal computer, laptop computer, integrated portion of a VR headset, or the like) may receive one or more audio streams (e.g., directly from an AP 105 or base station, via a network, a cloud, or the like), and may process the audio streams and send them to a VR device via wired or wireless communications. The audio processing device may take into account user position and available bandwidth when processing the audio streams, such that a sound field may be rendered by a VR device according to user position.

FIG. 2 illustrates an example of a virtual reality scenario 200 that supports processing of multiple audio streams based on available bandwidth in accordance with aspects of the present disclosure. In some examples, virtual reality scenario 200 may implement aspects of wireless communications system 100.

In some cases, a user 205 may use a VR system. For instance, user 205 may wear a VR headset, VR glasses or goggles, VR headphones, or a combination thereof. A VR system may operate using three degrees of freedom. In such examples, a user 205 may be free to rotate in any combination of three directions: pitch 210 (e.g., rocking or leaning forward and backward), roll 215 (rocking or leaning from side to side) and yaw 220 (e.g., rotating in either direction). A system having three degrees of freedom may allow a user to look or lean in multiple directions. However, user movement may be limited. That is, an audio processing device in such a VR system may detect rotational head movements, may determine which direction the user is looking, and may adjust a sound field accordingly.

A VR system having six degrees of freedom may provide improvements to a VR experience. In such examples, a user 205 may be free to rotate according to pitch 210, roll 215, yaw 220, as described above. Additionally, the user 205 may be free to move forward or backward along axis 225, side to side along axis 230, up and down along axis 235. A VR headset or other device of a VR system may detect rotational and translational movements. Thus, the VR device may determine a direction in which user 205 is looking, as well as a user position in the VR system. An audio processing device of a VR system having six degrees of freedom may adjust a sound field of the VR experience according to the direction in which user 205 is looking, and the position of user 205. For instance, as a user 205 moves away from an object in the VR experience, the object should sound quieter to user 205. Similarly, if an object in the VR experience moves away from user 205, then the object should sound quieter to user 205. Or, if a user 205 approaches an object, or if the object approaches user 205, the object should sound louder. In some examples, an audio processing device of the VR system may process objects and background noise according to user position, and adjustable threshold radius around user 205, and an available bandwidth, as described in greater detail with respect to FIGS. 5-7.

FIG. 3 illustrates an example of a virtual reality scenario 300 that supports processing of multiple audio streams based on available bandwidth in accordance with aspects of the present disclosure. In some examples, virtual reality scenario 300 may implement aspects of wireless communications system 100.

In some examples, audio streams may be captured via multiple microphone arrays 315. For instance, a user 305 may eventually participate in a virtual reality experience in a particular physical area 310. As user 305 moves along user navigation, user 305 may be exposed to a variety of sounds. Such sounds may be captured via microphone arrays 315 and rendered at the current position of user 305.

A sound field corresponding to physical area 310 may be captured via multiple microphone arrays 315. If only one microphone array 315 were utilized to capture a sound field, then it would not be possible to determine a direction, or distance, from a user position for a given audio source 320. Instead, a set of microphone arrays 315 distributed across or around the physical area 310 may be used to capture the sound field created by audio sources 320. For instance, microphone arrays 315 may perform one or more methods of beamforming to capture information regarding the location of audio sources 320 with respect to user 305 at any point along user navigation 325.

Each microphone array 315 may capture one or more audio channels. For instance, (e.g., in a fourth order scenario) each microphone array 315 may capture twenty five audio channels for each microphone array 315. In such examples, where there are five microphone arrays 315 corresponding to the physical area 310, the system may capture a total of 125 audio channels. The 125 audio channels may be captured by the microphone array and transmitted to an audio processing device. The audio processing device may process the 125 channels (e.g., by performing object-based encoding on one or more objects and HOA encoding on remaining audio streams), and output one or more encoded audio signals for rendering at a current user position (e.g., by a VR device). For instance, the 125 audio channels may be located on the cloud, and streamed directly to a VR device (e.g., a VR headset, smart glasses, or the like). In such examples, an audio processing device and the VR device may be co-located, or may be incorporated into the same device. In some examples, the 125 audio channels may be downloaded to an audio processing device (e.g., a desktop computer, laptop computer, smart phone, or the like) for audio processing. The audio processing device may be in communication with the VR device (e.g., via Wi-Fi, Bluetooth, or the like). The VR device may communicate, to the audio processing device, the location of user 305 within a physical area corresponding to physical area 310. The audio processing device may process the 125 channels according to the position of user 305 (e.g., by detecting energy at various locations within physical area 310), and may transmit, to the VR device, processed audio data (instead of providing the entirety of unprocessed audio channels). The VR device may receive the processed audio data, and render it for user 305 at a user position along user navigation 325 within the physical area 310. User 305 may thus hear and respond to one or more audio sources 320 that are processed and rendered according to the position of user 305. In some examples, as described in greater detail with respect to FIG. 7, the audio processing device may process the 125 channels according to user position and available bandwidth.

FIG. 4 illustrates an example of a virtual reality scenario 400 that supports processing of multiple audio streams based on available bandwidth in accordance with aspects of the present disclosure. In some examples, virtual reality scenario 400 may implement aspects of wireless communications system 100, and virtual reality scenario 300.

In some examples, an audio processing device may determine a location of one or more audio sources 420 based on audio data (e.g., one or more audio channels) captured by microphone arrays 415. As described in greater detail with respect to FIG. 3, microphone arrays 415 may capture audio data (e.g., 125 audio channels) generated by one or more audio sources 420. The captured audio channels may be transmitted to an audio processing device, which may be in communication with a VR device in use by user 405. The audio processing device may determine the location of one or more audio sources 420. For instance, user 405 may determine the location of audio source 420-a based on the audio channels received from microphone arrays 415-b. For instance, the audio processing device may perform a beamforming procedure to detect energy at a particular position (e.g., a particular coordinate in a three-dimensional system). The audio processing device may determine, based on the beamforming, that energy at some coordinates is low, and that energy at the location of audio source 420-a is high, and may thus determine the location of an object at audio source 420-a.

As discussed in greater detail with respect to FIG. 7, the audio processing device may perform object-based encoding on one or more objects with a portion of available bandwidth, and may generate an HOA audio stream including all remaining audio input (e.g., other objects and background noise). The audio processing device may determine which objects on which to perform audio-based encoding based on whether the objects are located within a threshold radius 425 of the current position of user 405. For instance, at a first position within a physical area of a VR experience, the audio processing device may determine that audio source 420-a is located within threshold radius 425-a. The audio processing device may perform object-based encoding on the object located at audio source 420-a.

In some examples, the audio processing device may adjust the size of the threshold radius 425 based on available bandwidth. For instance, at the first position, as discussed above, the audio processing device may locate an object at audio source 420-a, and perform object-based encoding on the object. However, user 405 may move along a user trajectory 410. The VR device may be in communication with the audio processing device (e.g., the VR device and the audio processing device may be integrated into a single device, such as a VR headset, or the audio processing device may be a separate device (e.g., a laptop computer, personal computer, smart phone, or the like) in wireless communication with the audio processing device), and the VR device may indicate the updated position of user 405 to the audio processing device. The audio processing device may identify an object at the location of audio source 420-a and audio source 420-b within threshold radius 425-b. If the audio processing device has sufficient bandwidth, it may perform object-based encoding on both the identified objects, and use any remaining bandwidth to generate an HOA audio stream including all background noise and any additional objects. However, if the audio processing device determines that it does not have sufficient bandwidth to process both the objects, then the audio processing device may decrease the size of threshold radius 425-h so that it only includes one object (e.g., audio source 420-b). In such examples, the audio processing device may perform object-based encoding on the object located at audio source 420-b, but may generate an HOA audio stream including background noise and the object located at audio source 420-a. Similarly, the audio processing device may increase the size of threshold radius 425 to include more objects if the available bandwidth permits. For instance, at he first position, if the audio processing device has sufficient available bandwidth, it may increase the threshold radius 425-a to include both the object located at audio source 420-a and the object located at audio source 420-b, and may perform object-based encoding on both objects. Thus, as described with respect to FIG. 7, the audio processing device may adjust a threshold radius 425 for a given position of a user 405, based on available bandwidth, and may perform object-based encoding on objects within the threshold radius 425 and HOA encoding on all remaining audio data.

FIG. 5 illustrates an example of a process flow 500 that supports processing of multiple audio streams based on available bandwidth in accordance with aspects of the present disclosure. In some examples, process flow 500 may implement aspects of wireless communications system 100, virtual reality scenario 300, and virtual reality scenario 400.

An audio processing device may receive one or more (e.g., P) audio streams (e.g., audio stream 1 through audio stream P). The audio streams may be, for instance, a number of audio channels captured by a set of one or more microphone arrays, as described in greater detail with respect to FIGS. 3 and 4.

At 505, the audio processing device may locate one or more objects within a threshold radius. If the threshold radius is fixed, then available bandwidth cannot be allocated to increase efficiency. This may result in poor rendering quality (e.g., at 515), decreased user experience, or inefficient use of available bandwidth. Instead, as described in greater detail with respect to FIG. 7, the audio processing device may adjust the threshold radius.

At 520, the audio processing device may extract the one or more objects within the threshold radius. As described above, if the threshold radius is fixed, then the number of objects within the threshold radius may change as a user changes position. Thus, at a first position too many objects may be located within the threshold radius, resulting in poor object-based encoding or poor object rendering at 515, or resulting in insufficient remaining bandwidth for weighted plane wave upsampling methods at 525. Similarly, at a second position, not enough objects may be located within the threshold radius to efficiently make use of available bandwidth. Instead, as described in greater detail with respect to FIG. 7, the audio processing device may adjust the threshold radius.

At 515, the audio processing device may render the objects at the user position. In some examples, the audio processing device may perform object-based encoding at 515 on the one or more objects located at 505 and extracted at 510.

At 520, the audio processing device may remove the contribution of the located one or more objects on the audio streams.

At 525, the audio processing device may perform a weighted plan wave upsampling method, as described in greater detail with respect to FIG. 6. A weighted plane upsampling method may include weighting each HOA stream of a set of HOA streams based on distance between the object and the user, converting each HOA stream of a number of HOA streams into a large number of plane waves delaying plane waves according to a listener position, and converting the plane waves to an HOA stream, multiplying the HOA stream by the weight, and combining each of the processed HOA streams to generate a single HOA stream at a current user position.

At 530, the audio processing device may add near field and far field components of a sound field. The audio processing device may output an audio signal that includes the object-based encoding of one or more objects, and an HOA stream including the remainder of the audio streams after extracting the one or more objects. The audio processing device may provide the audio signal for playback at a VR device. For instance, if the audio processing device is a personal computer, then the personal computer may transmit the audio signal to the VR device (e.g., a VR headset), and the VR headset may play the audio signal for a user at a current user position.

FIG. 6 illustrates an example of a process flow 600 that supports processing of multiple audio streams based on available bandwidth in accordance with aspects of the present disclosure. In some examples, process flow 600 may implement aspects of wireless communications system 100, virtual reality scenario 300, virtual reality scenario 400, and process flow 500.

An audio processing device may generate one or more HOA streams (e.g., HOA stream 1 through HOA stream P). For instance, as described in greater detail with respect to FIG. 7, the audio processing device may receive one or more audio streams, extract the contribution of one or more objects from the audio streams, resulting in one or more audio streams (HOA streams) on which to perform the rest of the weighted plain wave upsampling method.

At 605-a, the audio processing device may weight HOA stream 1 based on the distance to the user 630. The distance to the user 630 may be communicated to the audio processing device by the VR device used or worn by the user 630.

At 610-a, the audio processing device may convert HOA stream 1 into a large number of plane waves. The audio processing device may then be able to individually process each plane wave.

At 615-a, the audio processing device may delay each plane wave converted from an HOA stream at 610-a according to the user position (such that the plane waves arrive according to the determined distance). The audio processing device may then convert the delayed plane waves into an HOA stream.

At 620-a, the audio processing device may multiply the HOA stream by the weighted value determined at 605-a.

Similarly, at 605-a, the audio processing device may weight HOA stream P based on a distance to user 630. At 610-b, the audio processing device may convert the HOA stream P into a large number of plane waves. At 615-b, the audio processing device may delay each converted plane wave to the user position, and convert the plane waves to an HOA stream. At 620-b, the audio processing device may multiply the HOA stream by the weighted value determined at 605-b.

At 625, the audio processing device may combine each processed HOA stream into one total HOA stream. The audio processing device may output the HOA stream including each processed HOA stream to a user 630. In some examples, the HOA stream may include background noise, and one or more objects on which object-based encoding was not performed, as described in greater detail with respect to FIG. 7.

FIG. 7 illustrates an example of a process flow 700 that supports processing of multiple audio streams based on available bandwidth in accordance with aspects of the present disclosure. In some examples, process flow 700 may implement aspects of wireless communications system 100, virtual reality scenario 300, virtual reality scenario 400, process flow 500, and process flow 600. The audio processing device may decompose the audio streams into an HOA sound field for HOA encoding and a number of objects for object-based encoding. In the illustrative example of process flow 600, the audio processing device may have access to all audio data (e.g., multiple audio channels captured by a set of microphone arrays), but a VR device may provide improved user experience to a user 755 if it is not tethered to (e.g., unable to move freely away from) the audio processing device. The VR device may not have unlimited computing power. The audio processing device may have limited bandwidth. If the audio processing device efficiently utilizes its available bandwidth, as described herein, then the audio processing device may provide processed audio data to user 755 that can be successfully played back by the VR device.

At 705, the audio processing device may locate a number of objects within a threshold radius. The threshold may be initially fixed, may reset to a baseline value upon each iteration of the process described herein, or may remain at a particular value as a result of a previous iteration.

At 710, the audio processing device may determine an available bandwidth. The audio processing device may allocate a first portion of the available bandwidth for object-based encoding at 725, and a second portion of the available bandwidth for HOA encoding at 750.

At 715, the audio processing device may adapt the threshold radius according to the available bandwidth determined at 710. As described in greater detail with respect to FIG. 4, the audio processing device may decrease the size of the threshold radius to capture less objects within the threshold radius, or may increase the size of the threshold radius to capture more objects within the threshold radius, depending on the first portion of the available bandwidth allocated for object-based encoding at 710.

At 720, the audio processing device may extract the contribution of the objects located within the threshold radius from the total sound field including audio streams 1 through P.

At 725, the audio processing device may perform object-based encoding on the one or more objects within the threshold radius. The audio processing device may perform the object-based encoding at an object-based encoder of the deice. Object-based encoding may include, for instance, moving picture experts group 8 (MPEG8) encoding, audio advanced coding (AAC), or the like. Having performed object-based encoding on the one or more objects, the one or more encoded objects may be ready for rendering at a user position.

At 730, the audio processing device may determine a number of remaining objects that were not encoded at 725. For instance, the audio processing device may have identified a number of objects, but may have reduced the size of the threshold radius, leaving one or more additional objects on which object-based encoding has not been performed. the VR experience may include a set of specific objects and background noise. In a non-limiting illustrative example, the VR experience may represent a sporting event. One or more players in the sporting event may be located within the threshold radius. The audio processing device may perform object-based encoding, and the sounds resulting form the one or more players within the threshold radius may be rendered at the user position as individual objects. Additional players may be located outside of the threshold radius. These players (e.g., objects) may be converted to an HOA stream, which may be combined with background noise converted into an HOA stream as described herein, and encoded at 750.

In some examples, upon performing the object-based encoding at 725, the audio processing device may determine whether any available bandwidth should be redistributed for object-based encoding. If so, then at 710, the audio processing device may adjust the threshold radius to capture additional objects, may extract the additional objects at 720, and perform additional object-based encoding thereon at 725. This process may be done in a single iteration, or multiple iterations may be performed until a threshold amount or percentage of available bandwidth has been satisfied.

The audio processing device may use remaining available bandwidth (e.g., the allocated second portion of the available bandwidth determined at 710) to generate a high quality HOA stream that includes any remaining objects not encoded via object-based encoding and all background noise. That is, if all or too much available bandwidth is allocated to object-based encoding at 725, then the quality of background noise may be degraded, or background noise may not be included in the output signal for the VR device. Instead, the audio processing device may allocate some bandwidth for HOA encoding at 750 to ensure both high quality object-based encoding and high quality HOA encoding.

At 735, the audio processing device may remove the contribution to the audio streams 1 through P of the one or more objects extracted at 720. Having removed the contribution of the objects, the remaining audio streams may include background noise corresponding to the VR experience, as captured by one or more microphone arrays.

At 740, the audio processing device may perform a weighted plane wave upsampling method on the remainder of the audio streams, as described in greater detail with respect to FIG. 6.

At 745, the audio processing device may adapt an HOA order (e.g., resolution) of the HOA audio stream resulting from the weighted plane wave upsampling method performed at 740.

At 750, the audio processing device may perform HOA encoding on the HOA stream generated at 745, and the remaining objects converted to an HOA stream at 730.

The audio processing device may output an audio signal for user 755. The audio signal may include an HOA audio stream encoded at 750 (e.g., including the HOA stream resulting from converting the remaining objects to HOA streams at 730 and the HOA stream generated at 745), and may also include the one or more objects encoded at 725. By providing the processed audio signal to the VR device, the VR device may be able to use its limited computing power to render high quality sound fields to the user based on the user position, without having to perform all of the processing at the VR device. This may result in improved user experience, as most relevant objects within the VR experience may be object-based encoded, and an HOA audio stream encoded in the audio signal may include additional objects and background noise. The audio signal may be generated based on available bandwidth, allowing for high quality regardless of the available bandwidth of the audio processing device, and any changes in bandwidth over time, resulting in an uninterrupted VR experience for the user.

FIG. 8 shows a block diagram 800 of a device 805 that supports processing of multiple audio streams based on available bandwidth in accordance with aspects of the present disclosure. The device 805 may be an example of aspects of a device as described herein. The device 805 may include a receiver 810, an audio manager 815, and a transmitter 820. The device 805 may also include a processor. Each of these components may be in communication with one another (e.g., via one or more buses).

The receiver 810 may receive information (e.g., audio data) such as packets, user data, or control information associated with various information channels (e.g., audio channels captured by one or more microphone arrays, control channels, data channels, and information related to processing of multiple audio streams based on available bandwidth, etc.). Information may be passed on to other components of the device 805. The receiver 810 may be an example of aspects of the transceiver 1120 described with reference to FIG. 11. The receiver 810 may utilize a single antenna or a set of antennas, or a wired connection.

The audio manager 815 may receive, at the device, one or more audio streams, generate, by performing object-based encoding on the first set of one or more objects, an object-based audio stream, extract, from the one or more audio streams, a contribution of the first set of one or more objects, generate, by performing higher order ambisonics (HOA) encoding on a remainder of the one or more audio streams after the extracting, an HOA audio stream, identify an available bandwidth for processing the one or more audio streams, locate, based on the available bandwidth, a first set of one or more objects contributing to the one or more audio streams, the first set of one or more objects being located within a threshold radius from the device, and output, an audio feed including the HOA audio stream and the object-based audio stream. The audio manager 815 may be an example of aspects of the audio manager 1110 described herein.

The audio manager 815, or its sub-components, may be implemented in hardware, code (e.g., software or firmware) executed by a processor, or any combination thereof If implemented in code executed by a processor, the functions of the audio manager 815, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The audio manager 815, or its sub-components, may be physically located at various positions, including being distributed such that portions of functions are implemented at different physical locations by one or more physical components. In some examples, the audio manager 815, or its sub-components, may be a separate and distinct component in accordance with various aspects of the present disclosure. In some examples, the audio manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas, or a wired connection. The transmitter 820 may send processed audio signals to a VR device for playback to a user.

FIG. 9 shows a block diagram 900 of a device 905 that supports processing of multiple audio streams based on available bandwidth in accordance with aspects of the present disclosure. The device 905 may be an example of aspects of a device 805 or a device 115 as described herein. The device 905 may include a receiver 910, an audio manager 915, and a transmitter 940. The device 905 may also include a processor. Each of these components may be in communication with one another (e.g., via one or more buses).

The receiver 910 may receive information such as packets, user data, or control information associated with various information channels (e.g., control channels, data channels, and information related to processing of multiple audio streams based on available bandwidth, etc.). Information may be passed on to other components of the device 905. The receiver 910 may be an example of aspects of the transceiver 1120 described with reference to FIG. 11. The receiver 910 may utilize a single antenna or a set of antennas.

The audio manager 915 may be an example of aspects of the audio manager 815 as described herein. The audio manager 915 may include an audio stream manager 920, an available bandwidth manager 925, an object location manager 930, and an output manager 935. The audio manager 915 may be an example of aspects of the audio manager 1110 described herein.

The audio stream manager 920 may receive, at the device, one or more audio streams, generate, by performing object-based encoding on the first set of one or more objects, an object-based audio stream, extract, from the one or more audio streams, a contribution of the first set of one or more objects, and generate, by performing higher order ambisonics (HOA) encoding on a remainder of the one or more audio streams after the extracting, an HOA audio stream.

The available bandwidth manager 925 may identify an available bandwidth for processing the one or more audio streams.

The object location manager 930 may locate, based on the available bandwidth, a first set of one or more objects contributing to the one or more audio streams, the first set of one or more objects being located within a threshold radius from the device.

The output manager 935 may output, an audio feed including the HOA audio stream and the object-based audio stream.

The transmitter 940 may transmit signals generated by other components of the device 905. In some examples, the transmitter 940 may be collocated with a receiver 910 in a transceiver module. For example, the transmitter 940 may be an example of aspects of the transceiver 1120 described with reference to FIG. 11. The transmitter 940 may utilize a single antenna or a set of antennas.

FIG. 10 shows a block diagram 1000 of an audio manager 1005 that supports processing of multiple audio streams based on available bandwidth in accordance with aspects of the present disclosure. The audio manager 1005 may be an example of aspects of an audio manager 815, an audio manager 915, or an audio manager 1110 described herein. The audio manager 1005 may include an audio stream manager 1010, an available bandwidth manager 1015, an object location manager 1020, an output manager 1025, an user position manager 1030, a weighted plan wave upsampling procedure manager 1035, and a threshold radius manager 1040. Each of these modules may communicate, directly or indirectly, with one another (e.g., via one or more buses).

The audio stream manager 1010 may receive, at the device, one or more audio streams.

In some examples, the audio stream manager 1010 may generate, by performing object-based encoding on the first set of one or more objects, an object-based audio stream. In some examples, the audio stream manager 1010 may extract, from the one or more audio streams, a contribution of the first set of one or more objects. In some examples, the audio stream manager 1010 may generate, by performing higher order ambisonics (HOA) encoding on a remainder of the one or more audio streams after the extracting, an HOA audio stream. In some examples, converting the second set of one or more objects into a second HOA audio stream, where the HOA audio stream includes the second HOA audio stream. In some examples, the audio stream manager 1010 may adapt, based on the weighted plane wave upsampling procedure, an HOA order of the one or more audio streams, where generating the HOA audio stream is based on the adapted HOA order.

The available bandwidth manager 1015 may identify an available bandwidth for processing the one or more audio streams.

The object location manager 1020 may locate, based on the available bandwidth, a first set of one or more objects contributing to the one or more audio streams, the first set of one or more objects being located within a threshold radius from the device. In some examples, the object location manager 1020 may identify, based on a remaining available bandwidth after locating the first set of one or more objects contributing to the one or more audio streams, a second set of one or more objects contributing to the one or more audio streams.

The output manager 1025 may output, an audio feed including the HOA audio stream and the object-based audio stream. In some examples, the output manager 1025 may send the audio feed to one or more speakers of a user device.

The user position manager 1030 may identify a user position; where locating the first set of one or more objects contributing to the one or more audio streams within the threshold radius from the user is based on the user position. In some examples, the user position manager 1030 may receive an indication from a user device of the user position, where identifying the user position is based on the received indication.

The weighted plan wave upsampling procedure manager 1035 may perform a weighted plane wave upsampling procedure on the remainder of the one or more audio streams after the extracting, where generating the HOA audio stream is based on the weighted plane wave upsampling procedure. In some examples, the weighted plan wave upsampling procedure manager 1035 may convert the remainder of the one or more audio streams after the extracting to a set of plane waves. In some examples, the weighted plan wave upsampling procedure manager 1035 may delay the set of plane waves based on the identified user position. In some examples, the weighted plan wave upsampling procedure manager 1035 may apply a weighted value to each of the remainder of the one or more audio streams based on the identified user position. In some examples, the weighted plan wave upsampling procedure manager 1035 may combine the remainder of the one or more audio streams, where generating the HOA audio stream is based on the combining.

The threshold radius manager 1040 may adjust, based on a remaining available bandwidth after locating the first set of one or more objects contributing to the one or more audio streams, the threshold radius from the user based on the available bandwidth for processing the one or more audio streams. In some examples, the threshold radius manager 1040 may adjust the first set of one or more objects based on adjusting the threshold radius.

FIG. 11 shows a diagram of a system 1100 including a device 1105 that supports processing of multiple audio streams based on available bandwidth in accordance with aspects of the present disclosure. The device 1105 may be an example of or include the components of device 805, device 905, or a device as described herein. The device 1105 may include components for bi-directional voice and data communications including components for transmitting and receiving communications, including an audio manager 1110, an I/O controller 1115, a transceiver 1120, an antenna 1125, memory 1130, a processor 1140, and a coding manager 1150. These components may be in electronic communication via one or more buses (e.g., bus 1145).

The audio manager 1110 may receive, at the device, one or more audio streams, generate, by performing object-based encoding on the first set of one or more objects, an object-based audio stream, extract, from the one or more audio streams, a contribution of the first set of one or more objects, generate, by performing higher order ambisonics (HOA) encoding on a remainder of the one or more audio streams after the extracting, an HOA audio stream, identify an available bandwidth for processing the one or more audio streams, locate, based on the available bandwidth, a first set of one or more objects contributing to the one or more audio streams, the first set of one or more objects being located within a threshold radius from the device, and output, an audio feed including the HOA audio stream and the object-based audio stream.

The I/O controller 1115 may manage input and output signals for the device 1105. The I/O controller 1115 may also manage peripherals not integrated into the device 1105. In some cases, the I/O controller 1115 may represent a physical connection or port to an external peripheral. In some cases, the I/O controller 1115 may utilize an operating system such as iOS®, ANDROID®, MS-DOS®, MS-WINDOWS®, OS/2®, UNIX®, LINUX®, or another known operating system. In other cases, the I/O controller 1115 may represent or interact with a modem, a keyboard, a mouse, a touchscreen, or a similar device. In some cases, the I/O controller 1115 may be implemented as part of a processor. In some cases, a user may interact with the device 1105 via the I/O controller 1115 or via hardware components controlled by the I/O controller 1115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM and ROM. The memory 1130 may store computer-readable, computer-executable code 1135 including instructions that, when executed, cause the processor to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting processing of multiple audio streams based on available bandwidth).

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

FIG. 12 shows a flowchart illustrating a method 1200 that supports processing of multiple audio streams based on available bandwidth in accordance with aspects of the present disclosure. The operations of method 1200 may be implemented by a device or its components as described herein. For example, the operations of method 1200 may be performed by an audio manager as described with reference to FIGS. 8 through 11. In some examples, a device may execute a set of instructions to control the functional elements of the device to perform the functions described below. Additionally, or alternatively, a device may perform aspects of the functions described below using special-purpose hardware.

At 1205, the device may receive, at the device, one or more audio streams. The operations of 1205 may be performed according to the methods described herein. In some examples, aspects of the operations of 1205 may be performed by an audio stream manager as described with reference to FIGS. 8 through 11.

At 1210, the device may identify an available bandwidth for processing the one or more audio streams. The operations of 1210 may be performed according to the methods described herein. In some examples, aspects of the operations of 1210 may be performed by an available bandwidth manager as described with reference to FIGS. 8 through 11.

At 1215, the device may locate, based on the available bandwidth, a first set of one or more objects contributing to the one or more audio streams, the first set of one or more objects being located within a threshold radius from the device. The operations of 1215 may be performed according to the methods described herein. In some examples, aspects of the operations of 1215 may be performed by an object location manager as described with reference to FIGS. 8 through 11.

At 1220, the device may generate, by performing object-based encoding on the first set of one or more objects, an object-based audio stream. The operations of 1220 may be performed according to the methods described herein. In some examples, aspects of the operations of 1220 may be performed by an audio stream manager as described with reference to FIGS. 8 through 11.

At 1225, the device may extract, from the one or more audio streams, a contribution of the first set of one or more objects. The operations of 1225 may be performed according to the methods described herein. In some examples, aspects of the operations of 1225 may be performed by an audio stream manager as described with reference to FIGS. 8 through 11.

At 1230, the device may generate, by performing higher order ambisonics (HOA) encoding on a remainder of the one or more audio streams after the extracting, an HOA audio stream. The operations of 1230 may be performed according to the methods described herein. In some examples, aspects of the operations of 1230 may be performed by an audio stream manager as described with reference to FIGS. 8 through 11.

At 1235, the device may output, an audio feed including the HOA audio stream and the object-based audio stream. The operations of 1235 may be performed according to the methods described herein. In some examples, aspects of the operations of 1235 may be performed by an output manager as described with reference to FIGS. 8 through 11.

FIG. 13 shows a flowchart illustrating a method 1300 that supports processing of multiple audio streams based on available bandwidth in accordance with aspects of the present disclosure. The operations of method 1300 may be implemented by a device or its components as described herein. For example, the operations of method 1300 may be performed by an audio manager as described with reference to FIGS. 8 through 11. In some examples, a device may execute a set of instructions to control the functional elements of the device to perform the functions described below. Additionally, or alternatively, a device may perform aspects of the functions described below using special-purpose hardware.

At 1305, the device may receive, at the device, one or more audio streams. The operations of 1305 may be performed according to the methods described herein. In some examples, aspects of the operations of 1305 may be performed by an audio stream manager as described with reference to FIGS. 8 through 11.

At 1310, the device may identify an available bandwidth for processing the one or more audio streams. The operations of 1310 may be performed according to the methods described herein. In some examples, aspects of the operations of 1310 may be performed by an available bandwidth manager as described with reference to FIGS. 8 through 11.

At 1315, the device may locate, based on the available bandwidth, a first set of one or more objects contributing to the one or more audio streams, the first set of one or more objects being located within a threshold radius from the device. The operations of 1315 may be performed according to the methods described herein. In some examples, aspects of the operations of 1315 may be performed by an object location manager as described with reference to FIGS. 8 through 11.

At 1320, the device may adjust, based on a remaining available bandwidth after locating the first set of one or more objects contributing to the one or more audio streams, the threshold radius from the user based on the available bandwidth for processing the one or more audio streams. The operations of 1320 may be performed according to the methods described herein. In some examples, aspects of the operations of 1320 may be performed by a threshold radius manager as described with reference to FIGS. 8 through 11.

At 1325, the device may adjust the first set of one or more objects based on adjusting the threshold radius. The operations of 1325 may be performed according to the methods described herein. In some examples, aspects of the operations of 1325 may be performed by a threshold radius manager as described with reference to FIGS. 8 through 11.

At 1330, the device may generate, by performing object-based encoding on the first set of one or more objects, an object-based audio stream. The operations of 1330 may be performed according to the methods described herein. In some examples, aspects of the operations of 1330 may be performed by an audio stream manager as described with reference to FIGS. 8 through 11.

At 1335, the device may extract, from the one or more audio streams, a contribution of the first set of one or more objects. The operations of 1335 may be performed according to the methods described herein. In some examples, aspects of the operations of 1335 may be performed by an audio stream manager as described with reference to FIGS. 8 through 11.

At 1340, the device may generate, by performing higher order ambisonics (HOA) encoding on a remainder of the one or more audio streams after the extracting, an HOA audio stream. The operations of 1340 may be performed according to the methods described herein. In some examples, aspects of the operations of 1340 may be performed by an audio stream manager as described with reference to FIGS. 8 through 11.

At 1345, the device may output, an audio feed including the HOA audio stream and the object-based audio stream. The operations of 1345 may be performed according to the methods described herein. In some examples, aspects of the operations of 1345 may be performed by an output manager as described with reference to FIGS. 8 through 11.

What is claimed is:

1. A method for auditory enhancement at a device, comprising:
receiving, at the device, one or more audio streams;
identifying an available bandwidth for processing the one or more audio streams;
locating, based at least in part on the available bandwidth, a first set of one or more objects contributing to the one or more audio streams, the first set of one or more objects being located within a threshold radius from the device;
generating, by performing object-based encoding on the first set of one or more objects, an object-based audio stream;
extracting, from the one or more audio streams, a contribution of the first set of one or more objects;
generating, by performing higher order ambisonics (HOA) encoding on a remainder of the one or more audio streams after the extracting, an HOA audio stream; and
outputting, an audio feed comprising the HOA audio stream and the object-based audio stream.

2. The method of claim 1, further comprising:
identifying a user position; wherein locating the first set of one or more objects contributing to the one or more audio streams within the threshold radius from the user is based at least in part on the user position.

3. The method of claim 2, further comprising:
receiving an indication from a user device of the user position, wherein identifying the user position is based at least in part on the received indication.

4. The method of claim 2, further comprising:
performing a weighted plane wave upsampling procedure on the remainder of the one or more audio streams after the extracting, wherein generating the HOA audio stream is based at least in part on the weighted plane wave upsampling procedure.

5. The method of claim 4, wherein the weighted plane wave upsampling procedure further comprises:
converting the remainder of the one or more audio streams after the extracting to a plurality of plane waves;
delaying the plurality of plane waves based at least in part on the identified user position;
applying a weighted value to each of the remainder of the one or more audio streams based at least in part on the identified user position; and
combining the remainder of the one or more audio streams, wherein generating the HOA audio stream is based at least in part on the combining.

6. The method of claim 1, further comprising:
adjusting, based at least in part on a remaining available bandwidth after locating the first set of one or more objects contributing to the one or more audio streams, the threshold radius from the user based at least in part on the available bandwidth for processing the one or more audio streams; and
adjusting the first set of one or more objects based at least in part on adjusting the threshold radius.

7. The method of claim 1, further comprising:
identifying, based at least in part on a remaining available bandwidth after locating the first set of one or more objects contributing to the one or more audio streams, a second set of one or more objects contributing to the one or more audio streams; and
converting the second set of one or more objects into a second HOA audio stream, wherein the HOA audio stream comprises the second HOA audio stream.

8. The method of claim 1, further comprising:
adapting, based at least in part on the weighted plane wave upsampling procedure, an HOA order of the one or more audio streams, wherein generating the HOA audio stream is based at least in part on the adapted HOA order.

9. The method of claim 1, further comprising:
sending the audio feed to one or more speakers of a user device.

10. An apparatus for auditory enhancement at a device, comprising:
a processor,
memory coupled with the processor; and
instructions stored in the memory and executable by the processor to cause the apparatus to:
receive, at the device, one or more audio streams;
identify an available bandwidth for processing the one or more audio streams;
locate, based at least in part on the available bandwidth, a first set of one or more objects contributing to the one or more audio streams, the first set of one or more objects being located within a threshold radius from the device;
generate, by performing object-based encoding on the first set of one or more objects, an object-based audio stream;
extract, from the one or more audio streams, a contribution of the first set of one or more objects;
generate, by performing higher order ambisonics (HOA) encoding on a remainder of the one or more audio streams after the extracting, an HOA audio stream; and
output, an audio feed comprising the HOA audio stream and the object-based audio stream.

11. The apparatus of claim 10, wherein the instructions are further executable by the processor to cause the apparatus to:
identify a user position; wherein locating the first set of one or more objects contributing to the one or more audio streams within the threshold radius from the user is based at least in part on the user position.

12. The apparatus of claim 11, wherein the instructions are further executable by the processor to cause the apparatus to:
receive an indication from a user device of the user position, wherein identifying the user position is based at least in part on the received indication.

13. The apparatus of claim 11, wherein the instructions are further executable by the processor to cause the apparatus to:
perform a weighted plane wave upsampling procedure on the remainder of the one or more audio streams after the extracting, wherein generating the HOA audio stream is based at least in part on the weighted plane wave upsampling procedure.

14. The apparatus of claim 13, wherein the weighted plane wave upsampling procedure further comprises:
convert the remainder of the one or more audio streams after the extracting to a plurality of plane waves;
delay the plurality of plane waves based at least in part on the identified user position;
apply a weighted value to each of the remainder of the one or more audio streams based at least in part on the identified user position; and
combine the remainder of the one or more audio streams, wherein generating the HOA audio stream is based at least in part on the combining.

15. The apparatus of claim 10, wherein the instructions are further executable by the processor to cause the apparatus to:
adjust, based at least in part on a remaining available bandwidth after locating the first set of one or more objects contributing to the one or more audio streams, the threshold radius from the user based at least in part on the available bandwidth for processing the one or more audio streams; and
adjust the first set of one or more objects based at least in part on adjusting the threshold radius.

16. The apparatus of claim 10, wherein the instructions are further executable by the processor to cause the apparatus to:
identify, based at least in part on a remaining available bandwidth after locating the first set of one or more objects contributing to the one or more audio streams, a second set of one or more objects contributing to the one or more audio streams; and
convert the second set of one or more objects into a second HOA audio stream, wherein the HOA audio stream comprises the second HOA audio stream.

17. The apparatus of claim 10, wherein the instructions are further executable by the processor to cause the apparatus to:
adapt, based at least in part on the weighted plane wave upsampling procedure, an HOA order of the one or more audio streams, wherein generating the HOA audio stream is based at least in part on the adapted HOA order.

18. The apparatus of claim 10, wherein the instructions are further executable by the processor to cause the apparatus to:
send the audio feed to one or more speakers of a user device.

19. A non-transitory computer-readable medium storing code for auditory enhancement at a device, the code comprising instructions executable by a processor to:
receive, at the device, one or more audio streams;
identify an available bandwidth for processing the one or more audio streams;
locate, based at least in part on the available bandwidth, a first set of one or more objects contributing to the one or more audio streams, the first set of one or more objects being located within a threshold radius from the device;
generate, by performing object-based encoding on the first set of one or more objects, an object-based audio stream;
extract, from the one or more audio streams, a contribution of the first set of one or more objects;
generate, by performing higher order ambisonics (HOA) encoding on a remainder of the one or more audio streams after the extracting, an HOA audio stream; and
output, an audio feed comprising the HOA audio stream and the object-based audio stream.

20. The non-transitory computer-readable medium of claim 19, wherein the instructions are further executable to:
identify a user position; wherein locating the first set of one or more objects contributing to the one or more audio streams within the threshold radius from the user is based at least in part on the user position.
